(19) United States
(12) Patent Application Publication
(10) Pub. No.: US 2024/0121193 A1
(43) Pub. Date: Apr. 11, 2024

(54) TRAFFIC ENGINEERING DEVICE, TRAFFIC ENGINEERING METHOD, AND TRAFFIC ENGINEERING PROGRAM

(71) Applicant: Nippon Telegraph and Telephone Corporation, Tokyo (JP)

(72) Inventors: Yuhei HAYASHI, Musashino-shi, Tokyo (JP); Shohei KAMAMURA, Musashino-shi, Tokyo (JP); Satoshi NAKATSUKASA, Musashino-shi, Tokyo (JP); Yuki TAKEI, Musashino-shi, Tokyo (JP); Chiharu MORIOKA, Musashino-shi, Tokyo (JP); Takeaki NISHIOKA, Musashino-shi, Tokyo (JP); Yuki MIYOSHI, Musashino-shi, Tokyo (JP)

(21) Appl. No.: 18/273,242

(22) PCT Filed: Feb. 2, 2021
(86) PCT No.: PCT/JP2021/003716

§ 371 Date: Jul. 19, 2023

(51) Int. Cl. H04L 47/125

(52) U.S. Cl. CPC H04L 47/125

(57) ABSTRACT

An extraction unit extracts predetermined information from an outer header and an inner header of a tunneled packet passing through a network device in which congestion has occurred. An evaluation unit evaluates an order in which fine grain flows in a tunnel subdivided with reference to the extracted predetermined information are subject to TE, based on attribute information of the fine grain flows.

### TECHNICAL FIELD

The present invention relates to a traffic engineering device, a traffic engineering method, and a traffic engineering program.

### BACKGROUND ART

There has conventionally been known a technique called traffic engineering (TE) which bypasses traffic at a congestion point when congestion occurs in a network. For example, in a network to which a tunneling technique is applied, TE is executed by replacing a tunnel that changes a path thereof by measuring a traffic volume (see PTLS 1 to 6).

### CITATION LIST

### Patent Literature

[PTL 1] Japanese Patent Application Laid-open No. 2003-051845
[PTL 2] Japanese Patent Application Publication No. 2003-333090
[PTL 3] Japanese Patent Application Publication No. 2005-086487
[PTL 4] Japanese Patent Application Publication No. 2006-246117
[PTL 5] Japanese Patent Application Laid-open No. 2013-179483
[PTL 6] Japanese Patent Application Publication No. 2015-226236

### SUMMARY OF INVENTION

### Technical Problem

However, the conventional technique has a problem that the TE unit flow of the tunnel is rough, affecting the user. For example, TE based on information acquired by a device IF at a congestion point in the core network is not performed. It is also difficult to perform TE based on the metric of the user flow in the tunnel. For this reason, for example, even when the tunnel includes a flow having a high quality requirement, the tunnel is subject to TE, possibly affecting the user.

The present invention has been made in view of the above, and an object thereof is to efficiently solve congestion by suppressing the impact on a user in TE of a tunnel.

### Solution to Problem

In order to solve the foregoing problem and achieve this object, a traffic engineering device according to the present invention includes an extraction unit configured to extract predetermined information from an outer header and an inner header of a tunneled packet passing through a network device in which congestion has occurred, and an evaluation unit configured to evaluate an order in which flows in a tunnel subdivided with reference to the extracted predetermined information are subject to traffic engineering, based on attribute information of the flows.

### Advantageous Effects of Invention

According to the present invention, congestion can be solved efficiently by suppressing the impact on a user in TE of a tunnel.

### BRIEF DESCRIPTION OF DRAWINGS

FIG. 1 is a schematic diagram exemplifying an overview configuration of a TE device.

FIG. 2 is a diagram for explaining processing of the TE device.

FIG. 3 is a diagram for explaining processing of an evaluation unit.

FIG. 4 is a diagram for explaining processing of the evaluation unit.

FIG. 5 is a flowchart showing a TE processing procedure.

FIG. 6 is a diagram exemplifying a computer that executes a TE program.

### DESCRIPTION OF EMBODIMENTS

Hereinafter, an embodiment of the present invention will be described in detail with reference to the drawings. The present invention is not limited to the present embodiment. Further, in the description of the drawings, the same parts are denoted by the same reference signs.

[Configuration of Traffic Engineering (TE) Device]

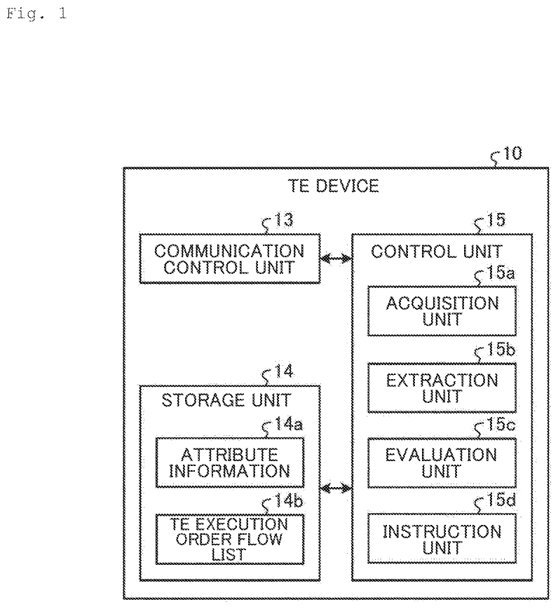

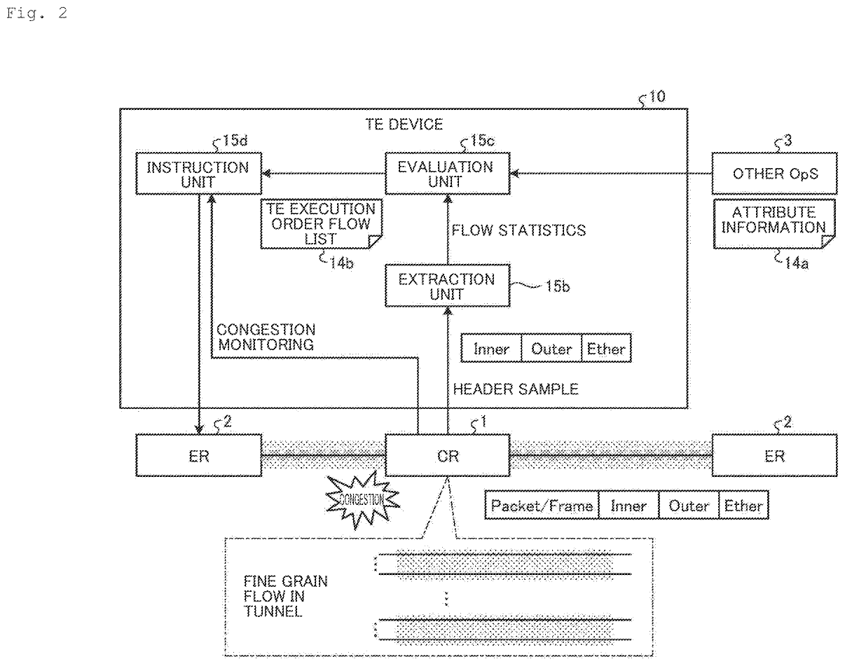

FIG. 1 is a schematic diagram exemplifying an overview configuration of a TE device 10. FIG. 2 is a diagram for explaining processing of the TE device. First, as shown in FIG. 1, the TE device 10 is realized by a general-purpose computer such as a personal computer and includes a communication control unit 13, a storage unit 14, and a control unit 15.

The communication control unit 13 is realized by an NIC (Network Interface Card) or the like, and controls communication between an external device such as a server and the control unit 15 via a network. For example, the communication control unit 13 controls communication between the control unit 15 and a core router (CR) in a core network, a network device such as an edge router (ER) for performing tunneling processing, and other operation systems (OpS) such as a server for managing user contract information.

The storage unit 14 is realized by a semiconductor memory element such as a RAM (Random Access Memory) or a Flash Memory, or a storage device such as a hard disk or an optical disk, and stores headers of packets used for TE processing, attribute information 14a, TE execution order flow list 14b generated by TE processing, and the like. Note that the storage unit 14 may also be configured to communicate with the control unit 15 via the communication control unit 13.

The control unit 15 is realized by using a CPU (Central processing Unit), an NP (Network processor), an FPGA (Field Programmable Gate Array), or the like, and executes a processing program stored in a memory. Thus, as exemplified in FIG. 1, the control unit 15 functions as an acquisition unit 15a, an extraction unit 15b, an evaluation unit 15c, and an instruction unit 15d. It should be noted that these functional units may be implemented in different hardware. For example, the extraction unit 15b may be mounted on a format converter, the evaluation unit 15c may be mounted on a collector, and the instruction unit 15d may be mounted on a controller. Also, the control unit 15 may include another functional unit.

The acquisition unit 15a performs header sampling of a packet from CR1 in which congestion occurs. Specifically, the acquisition unit 15a acquires an outer header, an inner header, and an Ethernet header excluding a payload of a packet, as shown in FIG. 2.

The acquisition unit 15a acquires the attribute information 14a from another OpS3 such as a user contract information management server, and stores the attribute information 14a in the storage unit 14. Here, the attribute information 14a includes, for example, band information of communication, a port number, quality request information such as a ToS (Type of Service) value and a CoS (Class of Service) value, and information related to important communication such as a destination SID and a VPN label value of an important user. For example, the port number can identify whether or not the flow is sensitive to delay. It is also possible to identify whether QoS is high or not by the ToS value and the CoS value.

The instruction unit 15d to be described later periodically monitors congestion in a device IF of a CR1 by telemetry or the like. The TE device 10 performs processing for the CR1 in which congestion has occurred.

The extraction unit 15b extracts predetermined information from an outer header and an inner header of a tunneled packet passing through the CR1 where congestion has occurred. For example, the extraction unit 15b extracts information including 5-tuple of the outer header and 5-tuple of the inner header of a packet passing through the device IF of the CR1 where congestion has occurred. Specifically, the extraction unit 15b performs format conversion of a sampled header, and extracts 5-tuple of the outer header and 5-tuple of the inner header of the tunnel by flow statistics (NetFlow).

The evaluation unit 15c evaluates the order of flows in a tunnel, which are subdivided with reference to extracted predetermined information, are subject to TE, based on the attribute information 14a of the flows. For example, on the basis of the attribute information 14a including any one or more of communication band information, information indicating a quality request, and information indicating important communication, the evaluation unit 15c evaluates a TE execution order in which TE is executed on the subdivided fine grain flows.

The evaluation unit 15c generates the TE execution order flow list 14b in which the evaluated fine grain flows are arranged in the order in which they are subject to TE.

Specifically, the evaluation unit 15c subdivides the flows in the tunnel in, for example, the unit of 5-tuple of an outer header and 5-tuple of an inner header. The flows subdivided here (referred to as “fine grain flows” hereinafter) are taken as, for example, candidates for flows subject to TE processing described below (referred to as “TE target flow candidates” hereinafter) in units of destination IPs of the inner head or in units of 5tuples of the outer header.

Then, the evaluation unit 15c refers to the attribute information 14a, evaluates the TE target flow candidates based on a plurality of viewpoints such as the size of a communication band, the level of a quality request, and whether or not the communication is important, and generates the TE execution order flow list 14b.

For example, the larger the band is, the smaller the number of times, and the TE can be ended. In addition, among the fine grain flows included in the TE target flow candidates, the larger the number of fine grain flows having low quality requirements, such as an application not sensitive to delay and a service having no high QoS, the less impact on the fine grain flow having high quality requirements. Further, if the important communication is not included, the impact is reduced. The evaluation unit 15c determines the TE execution order for the TE target flow candidates by taking the plurality of viewpoints into consideration in a predetermined priority order.

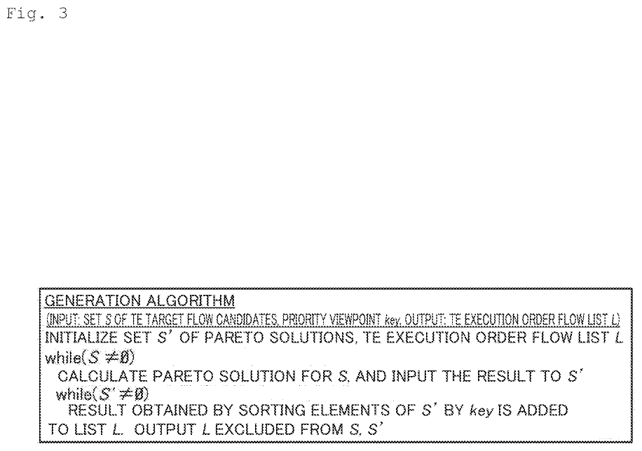

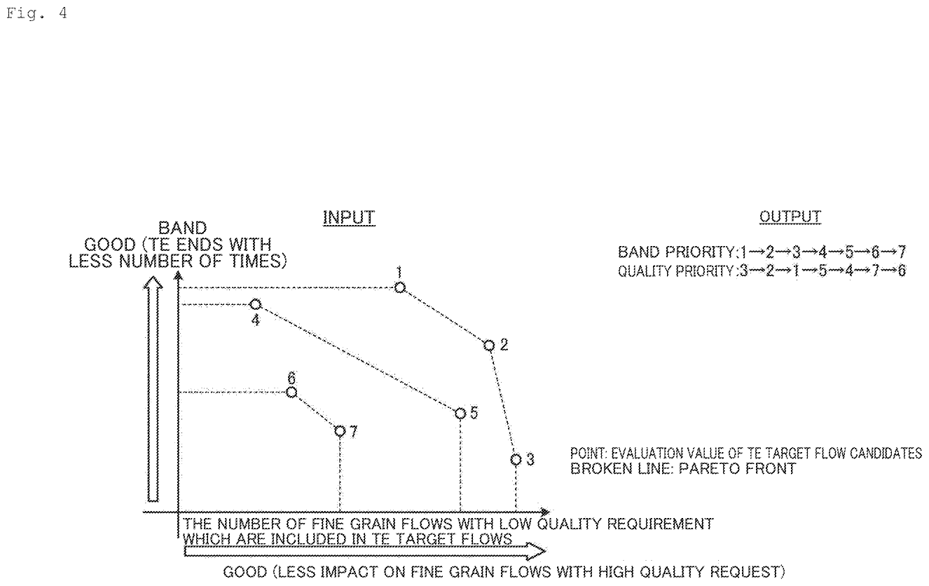

FIGS. 3 and 4 are diagrams for explaining of the processing of the evaluation unit. FIG. 3 illustrates an example of an algorithm for generating a TE execution order flow list of TE target flow candidates by using a multi-purpose optimization method. As shown in FIG. 3, the evaluation unit 15c outputs a TE execution order flow list L when a set S of TE target flow candidates is input as a preferential viewpoint key among the plurality of viewpoints. Specifically, the TE execution order flow list is generated by calculating Pareto solutions for the plurality of viewpoints and selecting a TE target flow candidate according to the preferential viewpoint from the set S of Pareto solutions.

FIG. 4 illustrates an example of a method of determining the TE execution order using Pareto solutions of the multi-purpose optimization method for two viewpoints, a band and a quality requirement. As described above, the larger the band is, the smaller the number of times, and the TE can be ended. In addition, among fine grain flows included in the TE target flow candidates, the larger the number of fine grain flows having a lower quality requirement, the less impact on the fine grain flows having a higher quality requirement.

Therefore, in the case of giving priority to the viewpoint of the band, the TE may be executed in the order of points 1->2->3->4->5->6->7->representing evaluation values of the TE target flow candidates in the example shown in FIG. 4. On the other hand, in the case where priority is given to the viewpoint of the quality requirement, it is understood that the TE may be executed in the order of points 3->2->1->5->4->7->6.

In this manner, the evaluation unit 15c determines the TE execution order from a plurality of viewpoints by using the multi-purpose optimization method. Therefore, the TE device 10 can generate the TE execution order flow list 14b corresponding to an operation policy.

The instruction unit 15d instructs an ER2 to execute TE for each fine grain flow in the order of the TE execution order flow list 14b, until the congestion of the CR1 is eliminated. Specifically, the instruction unit 15d monitors congestion in the device IF of the CR1 by telemetry or the like. Then, until the congestion of the CR1 is eliminated, the instruction on TE to the ER2 for the TE target flow candidates is repeated in the order of the TE execution order flow list 14b. Thus, the TE device 10 can efficiently solve congestion at an early stage by suppressing the impact on the user.

[Traffic Engineering (TE) Processing]

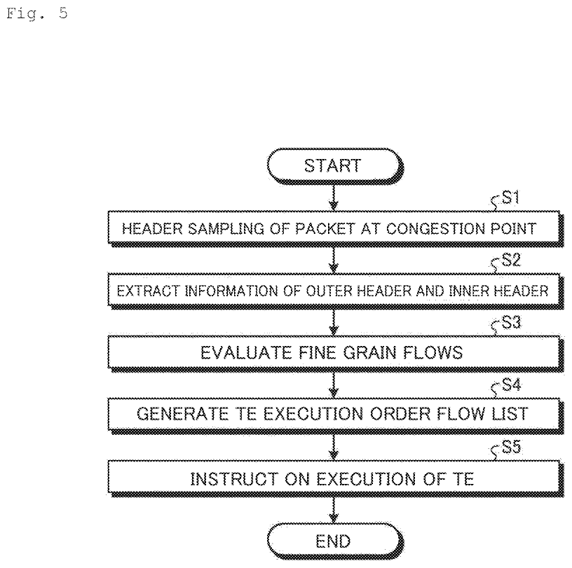

Next, the TE processing by the TE device 10 according to the present embodiment will be described with reference to FIG. 5.

FIG. 5 is a flowchart showing a TE processing procedure. The flowchart shown in FIG. 5 starts, for example, at a timing at which the CR of the TE device 10 detects congestion.

First, the acquisition unit 15a performs header sampling of a packet from the CR1 where the congestion has occurred, and acquires an outer header and an inner header (step S1).

Next, the extraction unit 15b extracts information including 5-tuple of the outer header and 5-tuple of the inner header (step S2).

The evaluation unit 15c evaluates the order of the TE targets on the basis of the attribute information 14a of the fine grain flows in the tunnel subdivided by referring to the extracted information (step S3). The evaluation unit 15c also generates the TE execution order flow list 14b in which the evaluated fine grain flows are arranged in the order in which they are subject to the TE (step S4).

Specifically, the evaluation unit 15c subdivides the flow in the tunnel in the unit of 5-tuple of the outer header and 5-tuple of the inner header. The evaluation unit 15c also bundles the subdivided fine grain flows by, for example, a destination IP unit of the inner header or a 5-tuple unit of the outer header, to obtain TE target flow candidates.

Then, the evaluation unit 15c refers to the attribute information 14a, and evaluates the TE execution order of the TE target flow candidates from a plurality of viewpoints such as the size of a communication band, the level of the quality request, and whether or not the communication is important. Then, the evaluation unit 15c determines the TE execution order for the TE target flow candidates and generates the TE execution order flow list 14b.

The instruction unit 15d instructs the ER2 to execute TE for each fine grain flow in the order of the TE execution order flow list 14b until the congestion of the CR1 is eliminated (step S5). In this manner, the series of TE processing ends.

As described above, in the TE device 10, the extraction unit 15b extracts predetermined information from the outer header and the inner header of a tunneled packet passing through the CR1 in which congestion has occurred. The evaluation unit 15c evaluates the order to be a target of traffic engineering on the basis of the attribute information 14a of the fine grain flows in the tunnel subdivided by referring to the extracted predetermined information.

Specifically, the evaluation unit 15c generates the TE execution order flow list 14b in which the evaluated fine grain flows are arranged in the order in which they are subject to the TE. The instruction unit 15d instructs the ER2 to execute TE for each fine grain flow in the order of the TE execution order flow list 14b until the congestion of the CR1 is eliminated.

Thus, the TE device 10 can preferentially set, as a TE target, a fine grain flow having a small impact on the user, a fine grain flow having a large band, or the like among fine grain flows obtained by subdividing the tunnel. Therefore, the TE device 10 can efficiently solve congestion in an early stage by suppressing the impact on the user in TE of a tunnel.

The extraction unit 15b extracts information including 5-tuple of the outer header and 5-tuple of the inner header. In this case, the evaluation unit 15c subdivides the flows in the tunnel in the unit of 5-tuple of the outer header and 5-tuple of the inner header. Thus, the TE device 10 can effectively subdivide the flows in the tunnel and extract the TE target flow candidates.

The evaluation unit 15c also evaluates the fine grain flows on the basis of the attribute information 14a including any two or more of communication band information, information indicating a quality request, and information indicating important communication. Thus, the TE device 10 can preferentially set, as a TE target, a fine grain flow not including a fine grain flow having a large band, a fine grain flow having a high quality requirement, and a fine grain flow of an important user. Thus, the TE device 10 can efficiently execute the TE according to the operation policy.

[Program]

It is also possible to create a program in which the processing executed by the TE device 10 according to the foregoing embodiment is described in a language executable by a computer. As one embodiment, the TE device 10 can be implemented by installing a TE program for executing the foregoing TE processing as package software or online software, into a desired computer. For example, by causing an information processing device to execute the TE program, the information processing device can be caused to function as the TE device 10. In addition, the information processing devices includes mobile communication terminals such as smartphones, mobile phones and PHSs (Personal Handyphone System) and slate terminals such as PDAs (Personal Digital Assistant). Furthermore, the functions of the TE device 10 may be implemented in a cloud server.

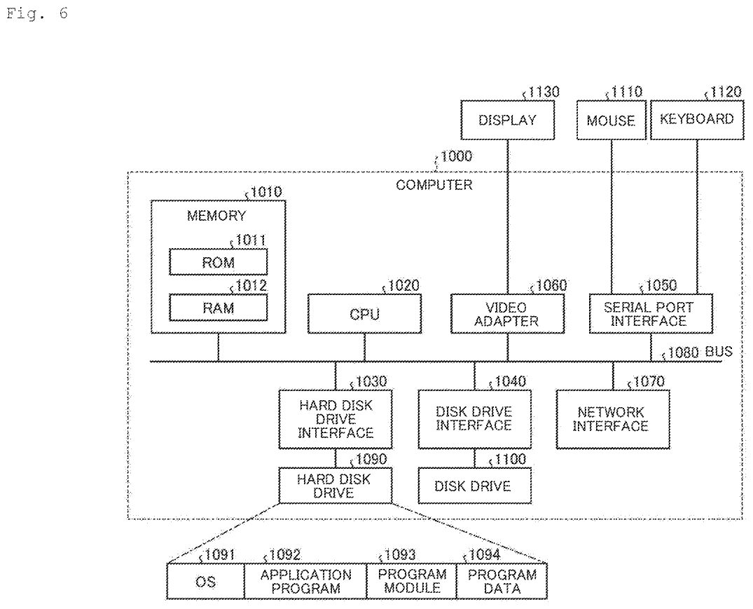

FIG. 6 is a diagram showing an example of a computer that executes the TE program. A computer 1000 has, for example, a memory 1010, a CPU 1020, a hard disk drive interface 1030, a disk drive interface 1040, a serial port interface 1050, a video adapter 1060, and a network interface 1070. These units are connected by a bus 1080.

The memory 1010 includes a ROM (Read Only Memory) 1011 and a RAM 1012. The ROM 1011 stores, for example, a boot program such as a BIOS (Basic Input Output System). The hard disk drive interface 1030 is connected to a hard disk drive 1031. The disk drive interface 1040 is connected to a disk drive 1041. A removable storage medium such as a magnetic disk or an optical disk, for example, is inserted into the disk drive 1041. A mouse 1051 and a keyboard 1052, for example, are connected to the serial port interface 1050. A display 1061, for example, is connected to the video adapter 1060.

Here, the hard disk drive 1031 stores, for example, an OS 1091, an application program 1092, a program module 1093, and program data 1094. Each of the pieces of information described in the foregoing embodiment is stored in, for example, the hard disk drive 1031 or the memory 1010.

The TE program is stored in the hard disk drive 1031 as the program module 1093 in which commands executed by the computer 1000 are described, for example. Specifically, the program module 1093 in which each processing executed by the TE device 10 described in the foregoing embodiment is written is stored in the hard disk drive 1031.

The data used for information processing by the TE program is stored in, for example, the hard disk drive 1031 as the program data 1094. Thereafter, the CPU 1020 reads the program module 1093 and the program data 1094 stored in the hard disk drive 1031 into the RAM 1012 when necessary, and executes each of the procedures described above.

Note that the program module 1093 and program data 1094 related to the TE program are not limited to being stored in the hard disk drive 1031, and may also be stored in, for example, a removable storage medium and read out by the CPU 1020 via the disk drive 1041, etc. Alternatively, the program module 1093 and the program data 1094 related to the TE program may be stored in another computer connected via a network such as a LAN (Local Area Network) or WAN (Wide Area Network) and may be read by the CPU 1020 via the network interface 1070.

Although the embodiment to which the invention made by the present inventor has been applied has been described above, the present invention is not limited by the description and the drawings that form a part of the disclosure of the present invention according to the present embodiment. That is, other embodiments, examples, operational techniques, and the like made by those skilled in the art or the like on the basis of the present embodiment are all included in the category of the present invention.

### REFERENCE SIGNS LIST

1 CR
2 ER
10 TE device
13 Communication control unit
14 Storage unit
14a Attribute information
14b TE execution order flow list
15 Control unit
15a Acquisition unit
15b Extraction unit
15c Evaluation unit
15d Instruction unit

1. A traffic engineering device, comprising a processor configured to perform operations comprising:
extracting predetermined information from an outer header and an inner header of a tunneled packet passing through a network device in which congestion has occurred; and
evaluating an order in which flows in a tunnel subdivided with reference to the extracted predetermined information are subject to traffic engineering, based on attribute information of the flows.

2. The traffic engineering device according to claim 1, wherein the processor is configured to generate a list in which the evaluated flows are arranged in the order in which the flows are subject to traffic engineering.

3. The traffic engineering device according to claim 2, wherein the processor is configured to instruct the network device to execute traffic engineering for each flow in the order of the list until congestion of the network device is resolved.

4. The traffic engineering device according to claim 1, wherein
the processor is configured to extract information including 5-tuple of the outer header and 5-tuple of the inner header, and
the processor is configured to subdivide the flows in the tunnel in units of 5-tuple of the outer header and 5-tuple of the inner header.

5. The traffic engineering device according to claim 1, wherein the processor is configured to evaluate the flows on the basis of attribute information including any two or more of communication band information, information indicating a quality request, and information indicating important communication.

6. A traffic engineering method executed by a traffic engineering device, the traffic engineering method comprising:
extracting predetermined information from an outer header and an inner header of a tunneled packet passing through a network device in which congestion has occurred; and
evaluating an order in which flows in a tunnel subdivided with reference to the extracted predetermined information are subject to traffic engineering, based on attribute information of the flows.

7. A non-transitory computer-readable medium storing instructions that, when executed, cause a computer to perform operations comprising:
extracting predetermined information from an outer header and an inner header of a tunneled packet passing through a network device in which congestion has occurred; and
evaluating an order in which flows in a tunnel subdivided with reference to the extracted predetermined information are subject to traffic engineering, based on attribute information of the flows.
